(19) United States
(12) Patent Application Publication
(10) Pub. No.: US 2017/0130487 A1
(43) Pub. Date: May 11, 2017

(54) CATCH MEMBER FOR A SAFETY LATCH

(71) Applicant: Safe and Care Ltd., Hong Kong (CN)

(72) Inventor: Jesper Andersen, Ry (DK)

(73) Assignee: Safe and Care Ltd., Hong Kong (CN)

(21) Appl. No.: 15/340,004

(22) Filed: Nov. 1, 2016

(30) Foreign Application Priority Data
Nov. 6, 2015 (GB) 1519663.7

(51) Int. Cl. E05B 65/44; E05B 15/02

(52) U.S. Cl. CPC E05B 65/44; E05B 15/022

(57) ABSTRACT

A childproof latch is provided which may be easily installed on the inside of a closure member without power tools or the need to measure. The latch may allow partial opening of the closure member but requires an additional actions to be carried out so that the enclosure which the member closes may be freely accessed.

The present invention relates to a catch member for a safety latches for drawers, cabinet doors and the like, and, more particularly, to “child-proof” latches that include features which make them difficult to be actuated by small children.

### BACKGROUND OF THE INVENTION

Drawers are commonly used in daily life in kitchens, bedrooms, offices, etc. to store a wide range of articles, some of which may be harmful to children. Small children may also attempt to climb on, or even in, drawers and cabinets in an effort to hide. Drawers and cabinets may house many types of materials which may be potentially hazardous to children such as medicines, household cleaners, knives, tools, paint, etc.

To prevent young children from accessing these storage areas, numerous items have been patented and sold, most of a multi-piece assembly. Generally, some sort of a longitudinal member with a hook portion is attached to the inside surface of a drawer or door to limit the amount the drawer or door may be opened. The hook portion may engage with a stop installed on a frame portion of the cabinet as the drawer or door is withdrawn. Only a small space may then remain for an adult to insert their finger to depress the longitudinal member such that the hook may clear the stop on the frame of the enclosure.

In many cases, these latches require at least two components, which need alignment during installation or adjustment after installation. These components generally include a stop portion, or catch, attached to the enclosure and a hook portion, or latch, attached to the inside of the drawer. This mechanism may further require a biasing member (springs, etc.) to bias the hook member against the stop member.

What is needed is a “child-proof” safety latch that is easy to install on the inside surface of a drawer, or door, and which includes more than one action which must be actuated to release the latch. Thus, a drawer, or cabinet door, may only be partially opened and its contents kept secure from children. Upon actuation of the more than one action by an adult, the contents may become accessible.

Many cabinets include a cross piece or horizontal portion against which the drawer abuts when it is closed. There are similar vertical cabinet pieces against which a hinged cabinet door abuts when closed. Typically and conveniently the catch portion of the safety mechanism is attached to this cross piece of the cabinet. Difficulties are often experienced, especially by the unskilled users, in attaching the catch portion of the safety mechanism to a cross piece of a cabinet.

It is thus an object of the present invention to provide a catch part of a safety mechanism which may preferably be moulded of plastic to provide a low cost safety latch.

It is a further object of the present invention to provide a childproof safety catch which may be easily installed on the interior of a drawer chest or cabinet without the need for taking measurements.

### DESCRIPTION OF THE DRAWINGS

FIG. 1: shows a front view of a set of cupboard drawings of the type in which the safety catch of the invention may be used;

FIG. 2 shows a cross section side view of FIG. 1, showing exemplary embodiment of the safety catch attachment of the invention in the installed position;

FIG. 3 shows an enlarged view of one of the catches of FIG. 2;

FIG. 4 shows an enlarged side view of the catch of FIG. 3 uninstalled, and

FIG. 5 shows an enlarged perspective view of a latch and part of the catch for use with the safety catch of the invention.

### DETAILED DESCRIPTION

The present invention is described more fully hereinafter with reference to the accompanying drawings, in which preferred embodiments of the invention are shown. This invention, may, however, be embodied in many different forms and should not be construed as limited to the embodiments set forth herein; rather, these embodiments are provided so that this disclosure will be thorough and complete, and will fully convey the scope of the invention to those skilled in the art.

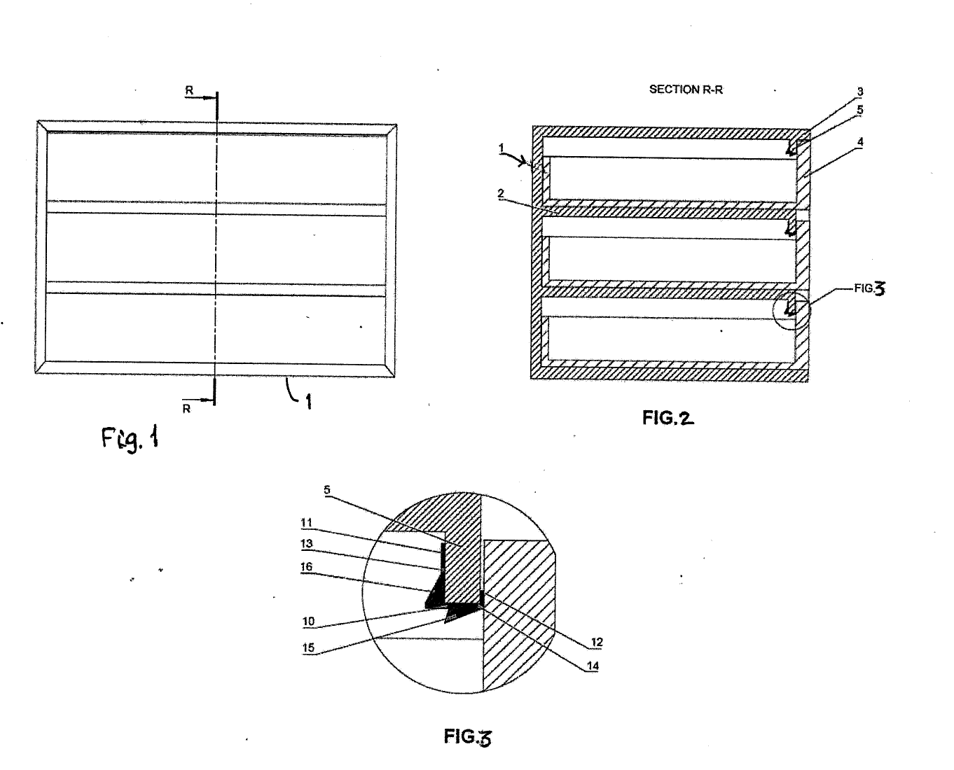

Referring now to FIG. 1 and FIG. 2, a drawer cabinet 1 is shown having a frame 2, a top 3 and drawer fronts 4. In addition the drawer cabinet 1 will have drawer voids corresponding to each drawer and sliding means on which each drawer may slide to be drawn in and out as well as other finishing panels (not shown). The drawer cabinet 1 also includes a cross piece 5 which is fixedly attached to the cabinet frame 2, and which extends horizontally at the level of the top of each drawer void and arranged at the front of the cabinet such that the drawer front 4 abuts against the cross piece 5 when the drawer is closed.

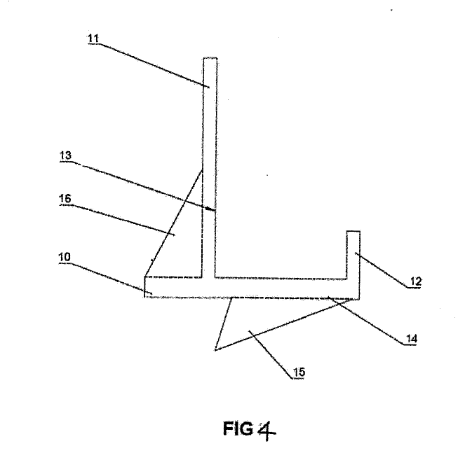

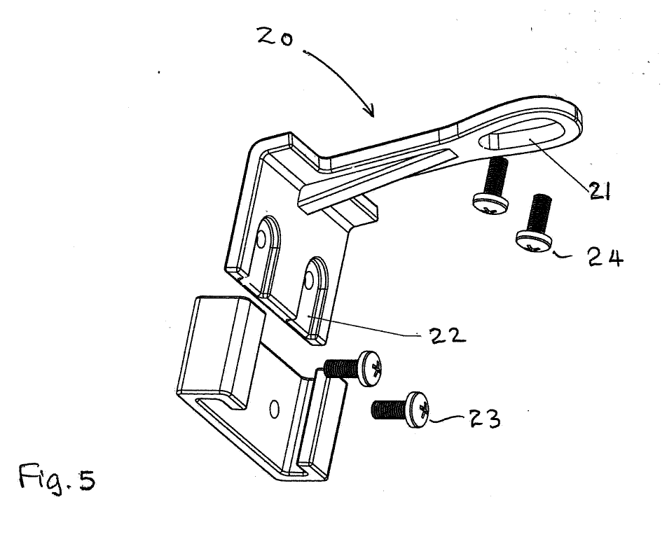

Referring now to FIG. 3 and FIG. 4, a first exemplary embodiment of a childproof catch member of a safety mechanism, according to the present invention, is illustrated in side view.

The catch member 10 includes a generally ‘L’ shaped member, with one side of the ‘L’, shown on the left in the FIGS. 3 and 4, being larger and forming a wall 11 with flat surface area 13 on the inner side facing the inside surface of the cabinet cross piece 5. This flat surface area 13 is covered in adhesive, which is most usefully provided in the form of adhesive tape and has a non-stick cover strip over the adhesive to prevent adhesive before use. When the catch is required to be attached to the cross piece 5, the cover strip is removed and this exposes the layer of adhesive and the catch member can them be attached to the cross piece 5 by pressing the flat surface 13 against the inside surface of the cross piece 5. The bottom web portion of the L shape has a width dimension which corresponds to the width of the cross piece such that the second horizontal wall of the L extends against the corresponding side of the cross piece 5 as shown. This is typically 18 mm, and provision of catch members at this dimension will fit most cabinets, although the catch member could be sized to alternative dimensions depending on the cabinet requirements. This results in a very easy assembly method since all the user has to do is to remove the tape and to orientate the larger side of the L to the inside of the cross piece and to position the catch member 10 with the bottom web 14 of the L against the lower side of the cross piece and to simply press the flat surface 13 against the inside surface of the cross piece 5. In this embodiment the front side of the L-shape is just in the form of a front lip 12 which serves to ensure that the catch member 10 is in position and the flat surface 13 is pressed against the side of the cross piece 5. The front lip 12 does not extend far upwards so as not to impinge on the aesthetic of the front face of the drawer 4. Similarly the bottom web portion 14 of the l is of a thickness which is sufficiently small to not interfere mechanically with the adjacent drawer below it so as not to exhibit an obtrusive appearance. This bottom portion 14 of the L extends inwardly beyond the wall 11 (in the direction of the drawer as shown in the fitted position) and provides support for a supporting web 16 which supports the wall 11 and helps to prevent any deformation during fitting which may otherwise make the fitting procedure more difficult. The bottom portion 14 of the L also supports a lever arm catch 15 which extends downwardly and this is the part which catches against a corresponding latch mounted on the drawer front 4. Any suitable latch shape could be used and attached to the front drawer 4 in a known conventional way. An example is shown in FIG. 5, with latch member 20 including an opening 21 which engages the catch 15 in the closed position of the drawer. In this FIG. 4 the latch member 20 is shown attachable to the inside of the drawer front 4 by means of a plate member 22 and screws 23. It may also be attached by means of adhesive. Similar in the FIG. 4 screws 24 are shown which may be used as the means of attachment of the catch to the inside surface of the frame edge 5.

The catch member 10 is preferably but not limited to being moulded of a resilient plastic. The childproof latch may be attached to the inner surface of a drawer to restrict the amount that the drawer may be easily opened. (A maximum of 30 mm is the European safety standards). The latching member may comprise any longitudinal member having a hook or detent portion for engaging the catch 15.

The catch member 10 may be a long profile which is fitted along part or all of the length of the cupboard frame part 5 with discrete catches arranged along its length which can be selected by the user to locate the corresponding latch fitted to the drawer in a preferred chosen position.

Thus the difficulty of attaching a catch to the inside surface of the cross piece is avoided. Traditional methods of attaching a catch member to the inside surface of the cross piece have required screws to be fitted against the inside surface of the cross piece which inevitably leads to impossible access problems which the unskilled user at least, with tools normally available in the home, is not able to overcome. With the present invention the catch member can be fitted by hand with the user facing the drawer casing and once the adhesive cover strip is removed the catch member can be fitted by hand by the user pressing the flat surface again the rear inside surface of the cross piece having made sure that the bottom of the U is pressed upwardly and the lip is hooked over the front of the cross piece, and the job is done. Surprisingly with this invention by means of the intimate and precise fit of the catch member in this configuration sufficient strength is provided to resist any horizontal pulling force exerted by child.

As well as a strip covered adhesive it would also be possible to use double-sided tape or hook-and-loop type fasteners, such as Velcro® being separately fitted to the inside surface of the cross piece and the flat surface of the catch member.

Thus, a childproof latch is provided which may be easily installed on the inside of a closure member without power tools or the need to measure. The latch may allow partial opening of the closure member but requires an additional actions to be carried out so that the enclosure which the member closes may be freely accessed.

It should be understood that although specific embodiments of the present invention have been described herein in detail, such descriptions are for purposes of illustration only and modifications may be made thereto within the scope of the invention.

The description and drawings illustratively set forth the presently preferred invention embodiment. We intend the description and drawings to describe this embodiment and not to limit the scope of the invention. Obviously, it is possible to modify these embodiments while remaining within the scope of the following claims. Therefore, within the scope of the claims one may practice the invention otherwise than as the description and drawings specifically show and describe.

1. A safety catch member for a childproof latch fitting mechanism, the safety catch comprising a L-shape configuration of a width dimension which corresponds approximately to the thickness of a front frame piece of a cupboard or drawer frame to which the childproof latch fitting mechanism is to be attached, wherein the L-shape safety catch member comprising a first wall and a second wall each of which walls abut against a corresponding side of the front frame piece of a cupboard or drawer frame.

2. A safety catch member according to claim 1, wherein the first wall is longer than the second wall.

3. A safety catch member according to claim 1, wherein in that the first wall comprises a flat surface which is destined to abut against the inside surface of a front frame piece.

4. A safety catch member according to claim 3, wherein flat surface of the first wall includes a layer of adhesive.

5. A safety catch member according to claim 4, wherein the layer of adhesive is covered with a removable non-adhesive protective strip.

6. A safety catch member according to claim 1, wherein the L-shape catch member includes a bottom portion which extends beyond the first wall co-linear with but in the opposite direction to the second wall.

7. A safety catch member according to claim 3, wherein first wall includes a web portion extending orthogonally behind the flat surface to provide additional strength and rigidity.

8. A safety catch member according to claim 6, wherein the web portion extends to the bottom portion and is supported by the extended part of the bottom portion.

9. A safety catch member according to claim 1, wherein the a catch is provided extending form the underside of the bottom portion and is configured to provide a releasable catch for a latch to prevent movement of the drawer or cupboard door in an outward or opening direction.

10. A safety catch member according to claim 1, wherein the second wall includes a vertical a lip just sufficiently long to extend over the front bottom edge of the front frame piece.
